(19) United States
(12) Patent Application Publication
(10) Pub. No.: US 2015/0161282 A1
(43) Pub. Date: Jun. 11, 2015

(54) Method and System for Smart URL Shortening Service

(71) Applicant: Yahoo! Inc., Sunnyvale, CA (US)

(72) Inventors: Daryl Mun-Kid Low, San Jose, CA (US); Bruno M. Fernandez-Ruiz, Mountain View, CA (US); Richard Allinson, Los Altos, CA (US)

(21) Appl. No.: 14/103,480

(22) Filed: Dec. 11, 2013

(51) Int. Cl. G06F 17/30; H04L 29/08

(52) U.S. Cl. CPC G06F 17/30887; H04L 67/02

(57) ABSTRACT

Method, system, and programs for retrieving resources. In one example, a request associated with a first location identifier is received from a client. A set of location identifiers associated with the first location identifier is retrieved. A response is sent that includes one or more location identifiers from the set of location identifiers and additional information to facilitate selection of one location identifier from the one or more location identifiers.

### BACKGROUND

1. Technical Field

The present teaching relates to methods and systems for retrieving content. Particularly, the present teaching is directed to methods, systems, and programming for retrieving content on a network based on a resource identifier.

2. Discussion of Technical Background

The Internet has made it possible for a user to electronically access virtually any content at anytime and from any location. To locate resources on the World Wide Web, domain names are commonly linked to IP addresses using some form of Uniform Resource Identifier (“URI”), including a Uniform Resource Locator (“URL”). URLs typically use alphanumeric characters to represent descriptive attributes, data structures, hierarchy, session information, transaction paths, or other information about the URL. This frequently results in the creation of very long URLs. URL shortening is a technique in which the URL used to access a resource may be altered and still direct to the underlying page. This is typically achieved by using an HTTP Redirect on a domain name that is short or easy to remember, which links to the web page that has a long URL.

Today's URL Shortening Services have significant shortcomings. Existing URL Shortening Services provide a limited one-to-one mapping of a “short URL” to a single and often times arbitrary “long URL.” Growing demand for mobile apps and other software applications specifically designed to run on mobile smartphones, tablet computers, mobile devices, and other computing devices has led content providers to generate different versions of the resources they develop to optimize the user experience across different host applications, environments, mobile apps, or operating systems. These resources are frequently accessible via short URLs. For example, the Yahoo! Messenger iOS application may be accessible through a short URL, such as “http://yahoo.it/fdsafads”, which corresponds to a long URL “http://itunes.apple.com/us/app/yahoo!-messenger-free-sms/id309219097?mt+8#”. However, in order to access the Yahoo! Messenger Android application located at “http://play.google.com/store/apps/details?id=com.yahoo.mobile.client.android.im&hl=en”, a different shortened URL, such as “http://yahoo.it/ewiorew”, must be created. Such one-to-one mapping does not insure that optimized content is provided to the client device, based on the software applications and operating system of the device itself. In addition, there is a need for a solution that allows multiple candidate URLs to be registered against a single shortened URL such that requesting the resource by a shortened URL would provide a user with one of several candidate URLs to achieve optimal display of that resource on a client device or optimal use of other software applications running on a client device.

### SUMMARY

The present teaching relates to the methods, systems and programming for retrieving information. Particularly, the present teaching is directed to methods, systems, and programming for retrieving content, accessible through a network, based on a resource identifier and selection process.

In an embodiment, a method, implemented on at least one computing device having at least one processor, storage, and a communication platform connected to a network for retrieving content on a network, such as the World Wide Web, is disclosed. A request associated with a first location identifier is received from a client. A location identifier according to an embodiment of the invention may be a URI, such as a uniform URL or URN. A second set of location identifiers associated with the first location identifier is retrieved. A response to the request is sent, wherein the response comprises the one or more location identifiers from the second set of location identifiers and information to facilitate selection of one location identifier from the one or more location identifiers.

In another embodiment, a system for implementing a computer implemented method is disclosed. The system comprises a client device, a URL mapping server, a URL database, and one or more content sources. The client device is configured for sending a request associated with a first location identifier. The URL mapping server is configured for receiving from the client device the request, retrieving a set of location identifiers associated with the first location identifier, and sending a response to the request. The URL database is configured for storing the set of location identifiers. The response comprises one or more location identifiers from the set of location identifiers and information from the one or more content sources to facilitate selection of one location identifier from the one or more location identifiers.

Other concepts relate to software for implementing the present invention. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In another embodiment, a machine-readable tangible and non-transitory medium having information recorded thereon is disclosed for measuring user engagement. The information, when read by the machine, causes the machine to receive from a client a request associated with a first location identifier, retrieve a set of location identifiers associated with the first location identifier, and send a response to the request. The response comprises one or more location identifiers from the set of location identifiers and information to facilitate selection of one location identifier from the one or more location identifiers.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a system diagram for existing URL Shortening Services;

FIGS. 2-3 depict exemplary system diagrams for retrieving content based on a resource identifier according to an embodiment of the present teaching;

FIG. 4 is a flowchart of an exemplary process for retrieving content based on a short URL, according to an embodiment of the present teaching;

FIGS. 5-6 depict exemplary embodiments of a networked environment in which content may be retrieved, according to different embodiments of the present teaching;

FIG. 7 depicts an exemplary diagram of a URL Mapping Server, according to an embodiment of the present teaching;

FIG. 8 depicts exemplary types of intelligence information;

FIG. 9 depicts a general mobile device architecture on which the present teaching can be implemented; and

FIG. 10 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present teaching relates to retrieving information. One embodiment of the present teaching further relates to retrieving content on a network from one of several long URLs registered against a single short URL. In one embodiment, a user selects, clicks, or otherwise inputs a first URL in a software environment running on a client device, such as a smart phone, tablet, laptop, desktop, or other computing device. A call for the first URL is made to a URL Mapping Server. Several URLs registered against the first URL are retrieved. The URL Mapping Server according to this embodiment may also retrieve information, including user-specific information, preferences, and logic functions, from an Intelligence Server. The URL Mapping Server of this embodiment may further narrow the multiple URLs registered against the first URLs to a set of candidate URLs. These candidate URLs are returned to the client device. In one embodiment, a testing script is also returned to the client device to select a URL to display on the client device. In one embodiment of the present teaching, the short URL is parameterized. In one embodiment, the present teaching converts or transcodes a URL from one format into another such that when a user selects, clicks, or otherwise inputs a first URL in a software environment running on a client device, a call for the first URL is made to a URL mapping server and the URL Mapping Server returns a set of candidate URLs including URLs in a format different than the input URL. By way of example, the first URL in one embodiment may appear in a Desktop Web format (e.g., http://finance.yahoo.com/q?s=YHOO). When the link is selected, clicked, activated, or otherwise input from a client device, the present teaching returns a link in a format compatible with software running on the client device, such as a URL in a Mobile Web format (e.g., http://m.yahoo.com/w/legobpenginc/finance/detailsn.sy=YHOO). In one embodiment, the URL Mapping Server may transcode an input URL to a second URL format that launches an application or software environment running on the client device.

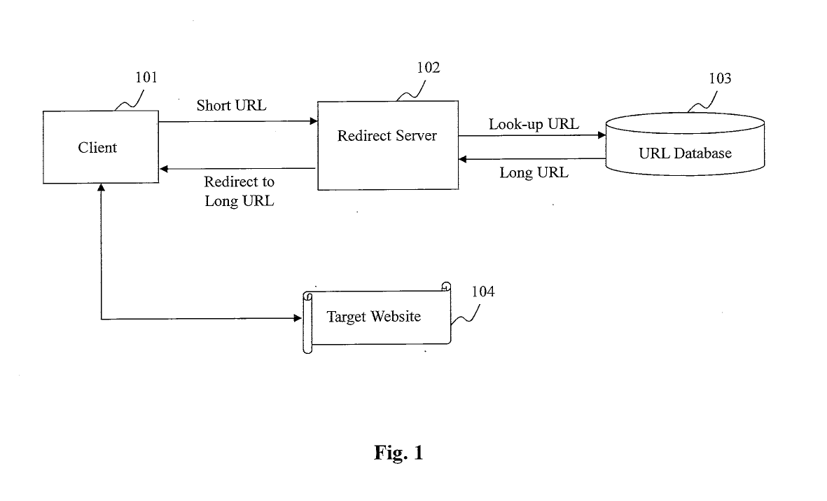

FIG. 1 depicts a system diagram for existing URL shortening services, which retrieve network resources using a one-to-one mapping of a short URL to a single long URL. In some existing systems, a short URL is associated with a registered URL and both URLs are logged in a URL database 103. Looking to access a target website 104, a user clicks on a short URL in some environment running on a client device 101. The client 101 makes a call to a redirect server 102 for the short URL. The redirect server looks up the short URL in a URL database, which returns the registered long URL. The redirect server 102 then answers the client device with a redirect to the registered long URL where the target website 104 may be accessed. The target website 104 is then loaded on the client 101.

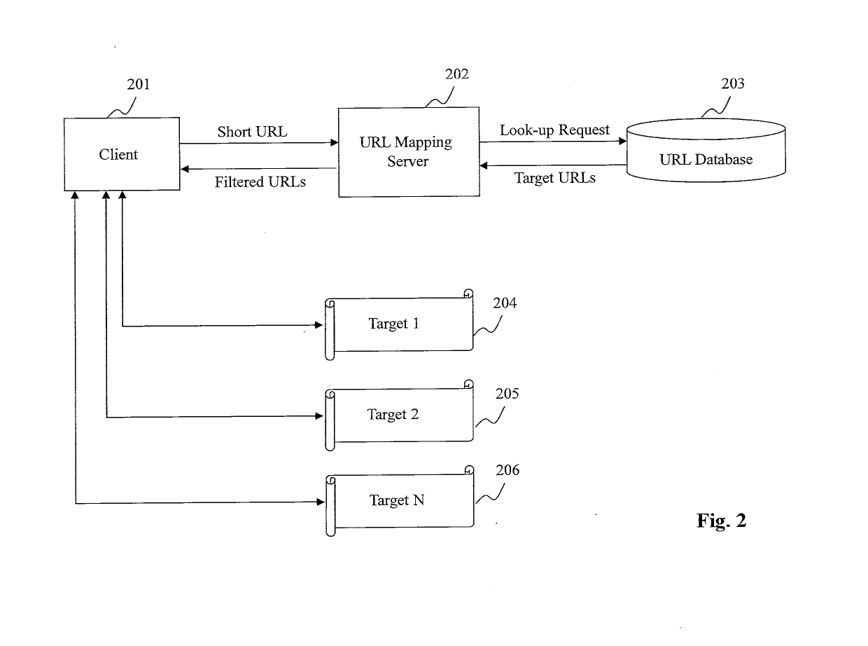

FIG. 2 depicts an exemplary system diagram for retrieving content based on a resource identifier according to an embodiment of the present teaching. In this embodiment, a user selects, clicks, or otherwise inputs a Short URL in a software environment running on a client device 201, such as a smart phone, tablet, laptop, desktop, or other computing device. It is understood that the term “Short URL” as used with respect to the present teaching does not require that the Short URL contain fewer characters than a Long URL or Target URL. A Short URL may be shorter, longer, or contain the same number of characters as the URLs associated therewith. A Short URL may also be a first URL that is selected, clicked, or otherwise input by a user requesting a resource. In one embodiment, the Short URL is a URL in one format, such as a Desktop Web or Mobile Web format or a format used in an iOS or Android environment.

A call that includes the Short URL is made to a URL Mapping Server 202. The URL Mapping Server 202 then sends a look-up request to a URL Database 203. Upon receipt of the look-up request, the URL Database 203 is searched for all URLs associated with the Short URL. The URLs associated with the Short URLs are retrieved and returned to the URL Mapping Server 202 as potential Target URLs. The URL Mapping Server 202 may then filter the returned set of Target URLs to a subset of those received from the URL Database based on a set of rules, conditions, parameters, or logic functions. The Filtered URLs are returned to the client device 201 along with conditions on which to load one or more of the pages accessible via the Filtered URLs. In one embodiment, the URL Mapping Server 202 returns a testing script that runs on the client device to determine which Target webpages 204, 205, 206, accessible via the Filtered URLs, to display on the client device 201. In another embodiment of the present teaching, the URL Mapping Server 202 determines which URLs are best for display on the client device 201. In one embodiment of the present teaching, the URL Mapping Server 202 may transcode the received URL to a second URL. The second URL may be in a different format than the received URL or may be directed towards launching an application or software environment installed on the client device. The URL Mapping Server 202 then creates a temporary web page with JavaScript logic. Both the temporary web page and best URLs for display are send to the client device. The temporary web pages is loaded and executed, at which time the JavaScript executes a short timer and attempts to launch a resource located at one of the accompanying URLs. If the launch succeeds, the user will be presented with the resource or resource will be loaded in the appropriate the software application on the client device and the JavaScript will cease executing. If the launch fails, the short timer will show that the same amount of time that has elapsed in real time and an attempt to launch the next accompanying URL is made. In another embodiment of the present teaching, the client device 301 leverages other programs, applications, and information resources on the client device to further narrow the candidate Filtered URLs returned by the URL Mapping Server or to select which Target to display.

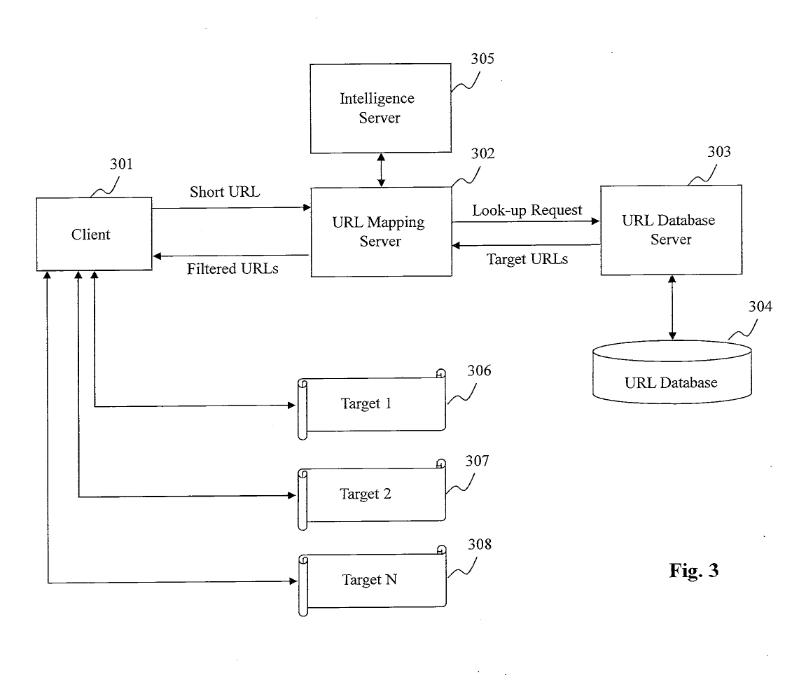

FIG. 3 depicts an exemplary system diagram for retrieving content based on a resource identifier according to another embodiment of the present teaching. In this embodiment, a user selects, clicks, or otherwise inputs a Short URL in a software environment running on a client device 301, such as a smart phone, tablet, laptop, desktop, or other computing device. A call that includes the Short URL is made to a URL Mapping Server 302. The URL Mapping Server 302 then sends a look-up request to a URL Database Server 303. Upon receipt of the look-up request, the URL Database Server 303 searches a URL Database 304 for one or more Target URLs associated with the Short URL. Target URLs associated with the Short URLs are retrieved from the URL Database 304 and returned by the URL Database Server 303 to the URL Mapping Server 302, which may then filter the returned set of Target URLs to a subset of those received from the URL Database Server 303 based on a set of rules or logic functions. The URL Mapping Server 302 according to this embodiment may also retrieve information, including user-specific information, preferences, and logic functions, from an Intelligence Server 305. The Filtered URLs are returned to the client device 301 along with conditions on which to load one or more pages located at the target Filtered URLs. In one embodiment, the URL Mapping Server 302 returns a testing script that runs on the client device to determine which Target web pages 306, 307, 308 accessible via the Filtered URLs, to display on the client device 301.

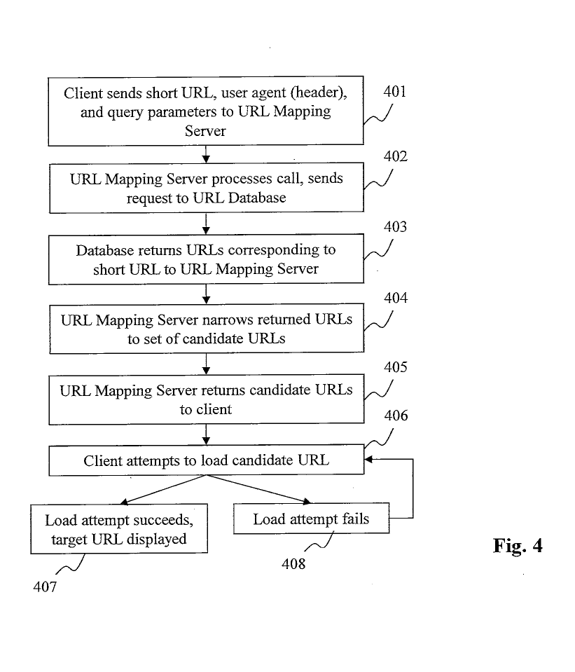

FIG. 4 is a flowchart of an exemplary process for retrieving content based on a short URL, according to an embodiment of the present teaching. In this embodiment, a client device first sends a call comprising a short URL, a header designating the user agent, and certain query parameters to a URL Mapping Server, as shown at 401. The URL Mapping Server processes the call and sends a request to a URL Database for URLs registered or otherwise associated with the short URL received from the client, as shown at 402. The URL Database then returns to the URL Mapping Server a set of URLs corresponding to or associated with the short URL received from the client, as shown at 403. The URL Mapping Server narrows the returned URLs to a set of candidate URLs, as shown at 404. The returned URLs may be narrowed based on user-specific information, preferences, logic functions, information regarding the user agent, and information contained in the query parameters to the URL Mapping Server. The URL Mapping Server then returns the narrowed set of candidate URLs to the client device, as shown at 405. The URL Mapping Server may also return a script or other program or application to the client device for use in selecting from among the candidate URLs a corresponding target resource to load on the client device. The client then attempts to load one of the candidate URLs returned from the URL Mapping Server, as shown at 406. If the resource loads successfully, the resource found at the target URL is displayed on the client, as shown at 407. If the load attempt fails, the client attempts to load the next candidate URL.

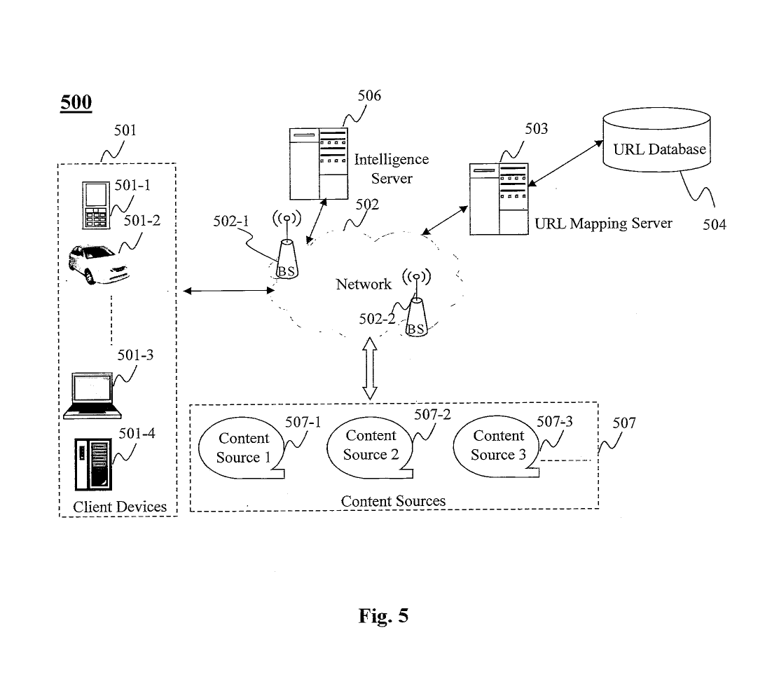

FIG. 5 is a high level depiction of an exemplary networked environment 500 in which content may be retrieved, according to an embodiment of the present teaching. The exemplary system 500 includes client devices 501, a network 502, an Intelligence Server 506, a URI Mapping Server 503, a URL Database 504, a Content Portal 505, an Intelligence Server 506, and Content Sources 507. The network 502 in system 500 can be a single network or a combination of different networks. For example, a network can be a local area network (LAN), a wide area network (WAN), a public network, a private network, a proprietary network, a Public Telephone Switched Network (PSTN), the Internet, a wireless network, a virtual network, or any combination thereof. A network may also include various network access points, e.g., wired or wireless access points such as base stations or Internet exchange points 502-1, 502-2, through which a data source may connect to the network in order to transmit information via the network. Users 501 may be of different types such as users connected to the network via desktop connections (501-4), users connecting to the network via wireless connections such as through a laptop (501-3), a handheld device (501-1), or a built-in device in a motor vehicle (501-2). A user may send a query to the URL Mapping Server 503 via the network 502 and receive candidate URLs from the URL Mapping Server 503 through the network 502. The content sources 507 may include multiple content sources 507-1, 507-2, . . . , 507-3. A content source may correspond to a web page host corresponding to an entity, whether an individual, a business, or an organization such as USPTO.gov, a content provider such as cnn.com and Yahoo.com, or a content feed source such as Twitter or blogs. The URL Mapping Server 503 may access information from any of the content sources 507-1, 507-2, . . . , 507-3 and rely on such information to respond to a call for a short URL, provide information regarding existing objects, or to classify new or existing entities as objects within the system. The URL Mapping Server 503 may also access additional information, via the network 502, stored in the network, which may contain, e.g., structured information such as information about certain objects, identifiers assigned to objects, graphs of entities based on their content, events that link different objects together, etc.

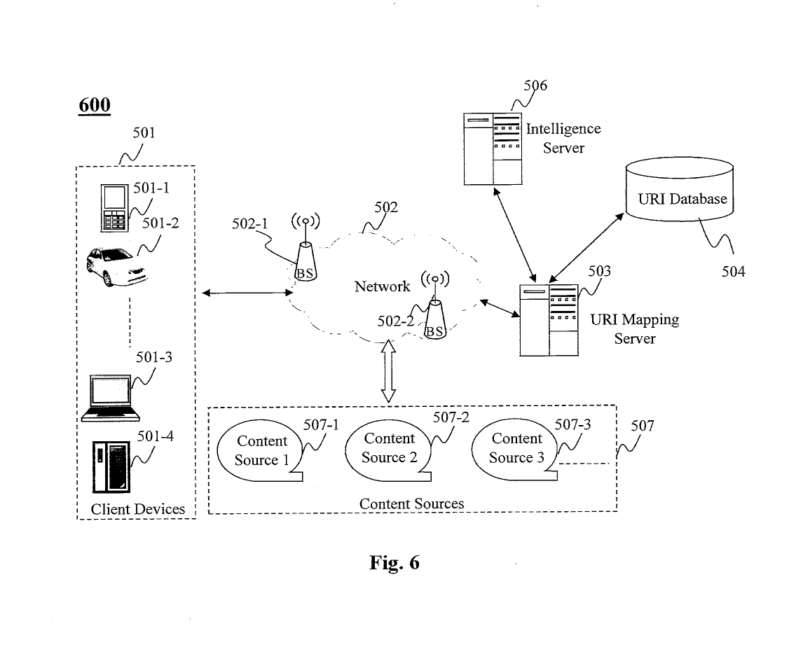

FIG. 6 is a high level depiction of an exemplary networked environment 500 in which content may be retrieved, according to another embodiment of the present teaching. In this embodiment, the Intelligence Server 506 is connected directly to backend of the URI Mapping Server 501

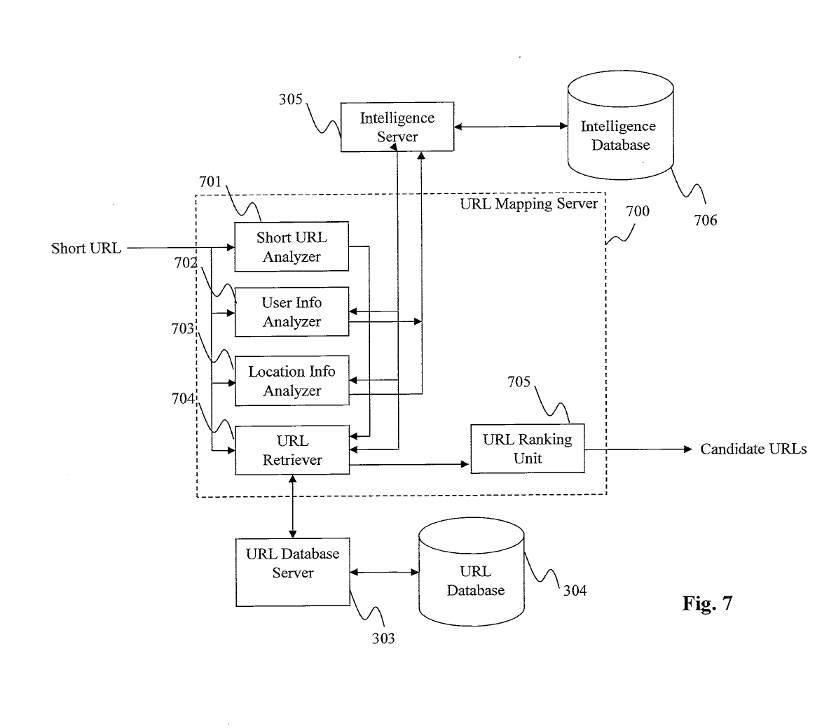

FIG. 7 depicts an exemplary diagram of a URL Mapping Server, according to an embodiment of the present teaching. In this embodiment, the URL Mapping Server 700 comprises several modules: a Short URL Analyzer 701; a User Information Analyzer 702; a Location Information Analyzer 703; a URL Retriever 704; and a URL Ranking Unit 705. The URL Mapping Server 700 of this embodiment is connected to an Intelligence Server 305 that draws from information maintained in an Intelligence Database 706. The Intelligence Database 706 may keep information regarding a specific user, location-dependent information, and information about specific web pages, resources, or resource identifiers. The URL Mapping Server 700 of this embodiment is further connected to a URL Database Server 303, which is capable of accessing and drawing information from a URL Database 304.

In one embodiment, the URL Mapping Server receives a Short URL, which is processed by the Short URL Analyzer 701, which is in communication with the URL Retriever 704. The Short URL may alternatively be provided directly to any of the User Information Analyzer 702, Location Information Analyzer 703, or URL Retriever 704. The User Information Analyzer 702 may also receive information from the Intelligence Server 305, including but not limited to information regarding a specific user, a user's explicit or implicit preferences, general knowledge, and logic functions. Similarly, the Location Information Analyzer 703 may receive information from the Intelligence Server 305 that is pertinent to some location designation. Such designations may include the actual geographic location of the client device that transmitted the short URL, a default location, or a location specifically requested. The URL Retriever 704 of this embodiment is responsible for requesting the resources associated with the received Short URL from the URL Database Server 303 and using information supplied by any one of the Short URL Analyzer 701, User Information Analyzer 702, Location Information Analyzer 703, or directly from the Intelligence Server 305 to filter the candidate URLs received from the URL Database Server 303. The URL Retriever of this embodiment then provides the filtered candidate URLs to the URL Ranking Unit 705, which may order the candidate URLs according to the likelihood that the resource located at each candidate URL is the optimal resource for display on the requesting client device.

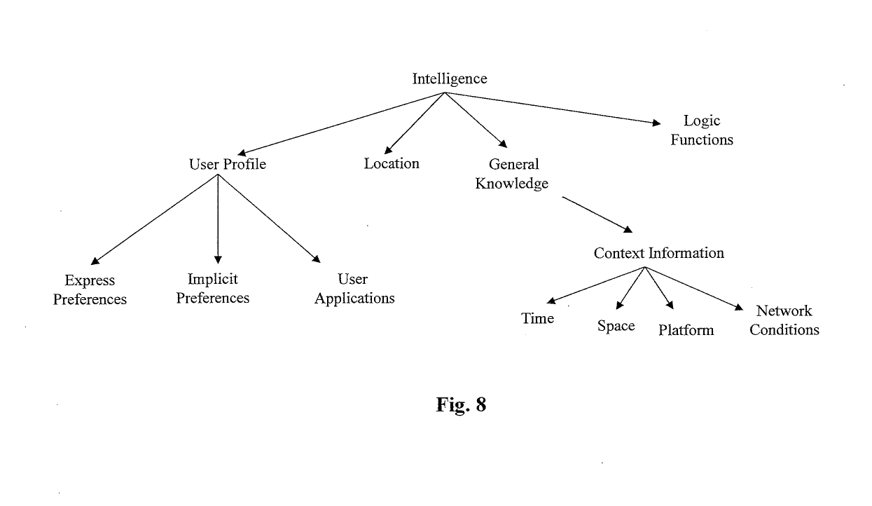

FIG. 8 illustrates different types of intelligence that may be detected and utilized in ranking candidate URLs, according to an embodiment of the present teaching. In this illustration, Intelligence comprises information derived from a user's profile, location data, general knowledge, or logic functions. A user profile may contain express or implicit preferences associated with a user or applications associated with a user profile. In this illustration, general knowledge may include context information related to several categories of data, including, but not limited to, time, space, platform, and network conditions. Time related information can be time of the year (e.g., a particular month from which season can be inferred), day of a week, specific time of the day, etc. Such information may provide insights as to what particular set of interests associated with a user may be more relevant. To infer the particular interests of a user at a specific moment may also depend on the locale that the user is in and this can be reflected in the space related context information, such as which country, what locale (e.g., tourist town), which facility the user is in (e.g., at a grocery store), or even the spot the user is standing at the moment (e.g., the user may be standing in an aisle of a grocery store where cereal is on display). Other types of context information includes the specific platform related to the user's device, e.g., Smartphone, Tablet, laptop, desktop, bandwidth/data rate allowed on the user's device, which will impact what types of content may be effectively presented to the user. In addition, the network related information such as state of the network where the user's device is connected to, the available bandwidth under that condition, etc. may also impact what content should be recommended to the user so that the user can receive or view the recommended content with reasonable quality.

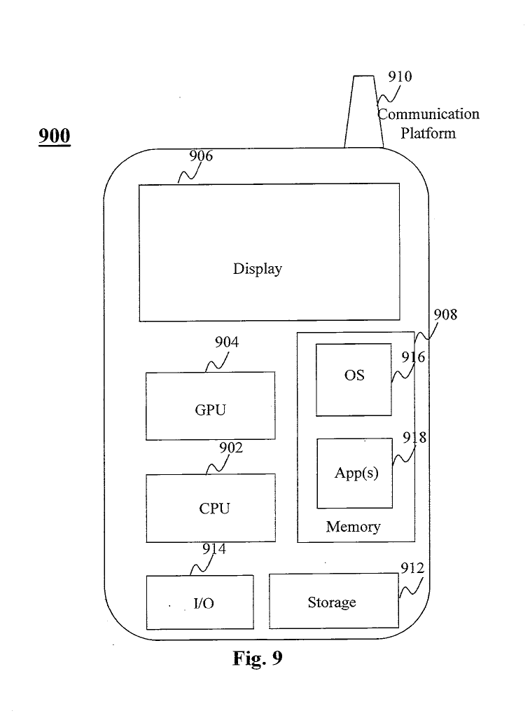

FIG. 9 depicts a general mobile device architecture on which the present teaching can be implemented. In this example, the user device on which content is presented is a mobile device 900, including but is not limited to, a smart phone, a tablet, a music player, a handled gaming console, a global positioning system (GPS) receiver. The mobile device 900 in this example includes one or more central processing units (CPUs) 902, one or more graphic processing units (GPUs) 904, a display 906, a memory 908, a communication platform 910, such as a wireless communication module, storage 912, and one or more input/output (I/O) devices 914. Any other suitable component, such as but not limited to a system bus or a controller (not shown), may also be included in the mobile device 900. As shown in FIG. 9, a mobile operating system 916, e.g., iOS, Android, Windows Phone, etc., and one or more applications 918 may be loaded into the memory 908 from the storage 912 in order to be executed by the CPU 902. The applications 918 may include a browser or any other suitable mobile apps for receiving and rendering personalized content streams on the mobile device 900. Execution of the applications 918 may cause the mobile device 900 to perform the processing as described above. For example, the display of content to the user may be made by the GPU 904 in conjunction with the display 906. User interactions with the content may be achieved via the I/O devices 914 and provided via the communication platform 910.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

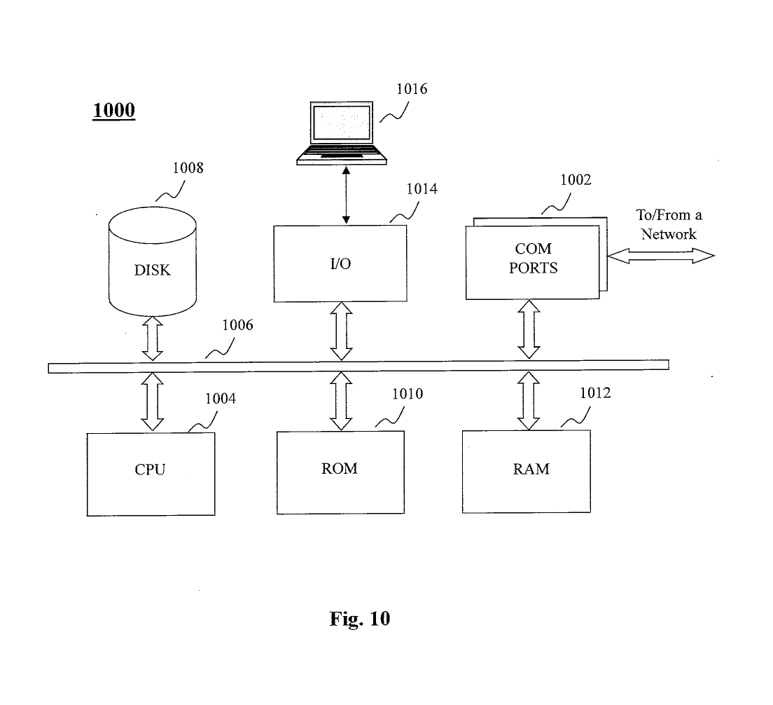

FIG. 10 depicts a general computer architecture on which the present teaching can be implemented and has a functional block diagram illustration of a computer hardware platform that includes user interface elements. The computer may be a general-purpose computer or a special purpose computer. This computer 1000 can be used to implement any components of the user engagement measurement architecture as described herein. Different components of the system in the present teaching can all be implemented on one or more computers such as computer 1000, via its hardware, software program, firmware, or a combination thereof. Although only one such computer is shown, for convenience, the computer functions relating to the target metric identification may be implemented in a distributed fashion on a number of similar platforms, to distribute the processing load.

The computer 1000, for example, includes COM ports 1002 connected to and from a network connected thereto to facilitate data communications. The computer 1000 also includes a central processing unit (CPU) 1004, in the form of one or more processors, for executing program instructions. The exemplary computer platform includes an internal communication bus 1006, program storage and data storage of different forms, e.g., disk 1008, read only memory (ROM) 1010, or random access memory (RAM) 1012, for various data files to be processed and/or communicated by the computer, as well as possibly program instructions to be executed by the CPU. The computer 1000 also includes an I/O component 1014, supporting input/output flows between the computer and other components therein such as user interface elements 1016. The computer 1000 may also receive programming and data via network communications.

Hence, aspects of the methods of receiving user queries and returning a response, e.g., a URL associated with dynamically generated web pages or the content contained in the dynamically generated web pages, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of the search engine operator or other explanation generation service provider into the hardware platform(s) of a computing environment or other system implementing a computing environment or similar functionalities in connection with generating explanations based on user inquiries. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the dynamic relation/event detector and its components as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one machine, each of which has at least one processor, storage, and a communication platform connected to a network, comprising:
receiving from a client a request associated with a first location identifier;
retrieving a set of location identifiers associated with the first location identifier; and
sending a response to the request, wherein, the response comprises one or more location identifiers from the set of location identifiers and information to facilitate selection of one location identifier from the one or more location identifiers.

2. The method of claim 1, wherein the first location identifier comprises a short Uniform Resource Locator (URL).

3. The method of claim 1, wherein the location identifiers associated with the first location identifier comprise one or more URLs.

4. The method of claim 1, further comprising transcoding the first location identifier into a location identifier having a different format than the first location identifier.

5. The method of claim 1, further comprising filtering the set of location identifiers associated with the first location identifier.

6. The method of claim 1, further comprising returning to the client an executable script for selecting for display one or more resources located at the one or more location identifiers.

7. The method of claim 3, further comprising attempting to load on the client one or more resources located at the one or more location identifiers.

8. A system for retrieving network resources comprising:
a client device configured for sending a request associated with a first location identifier;
a URL mapping server configured for
receiving from the client device the request,
retrieving a set of location identifiers associated with the first location identifier, and
sending a response to the request;
a URL database configured for storing the set of location identifiers; and
one or more content sources,
wherein,
the response comprises one or more location identifiers from the set of location identifiers and information from the one or more content sources to facilitate selection of one location identifier from the one or more location identifiers.

9. The system of claim 8, wherein the first location identifier comprises a short Uniform Resource Locator (URL).

10. The system of claim 8, wherein the location identifiers associated with the first location identifier comprise one or more URLs.

11. The system of claim 8, wherein the URL Mapping Server is configured for transcoding a received location identifier into a location identifier having a different format than the first location identifier.

12. The system of claim 8, wherein the URL mapping server is further configured for filtering the set of location identifiers associated with the first location identifier.

13. The system of claim 8, wherein the URL mapping server is further configured for returning to the client device an executable script for selecting for display one or more resources located at the one or more location identifiers.

14. The system of claim 10, wherein the URL mapping server is further configured for attempting to load on the client device one or more resources located at the one or more location identifiers.

15. A machine-readable tangible and non-transitory medium having information recorded thereon for measuring user engagement, wherein the information, when read by the machine, causes the machine to perform the following:
receiving from a client a request associated with a first location identifier;
retrieving a set of location identifiers associated with the first location identifier; and
sending a response to the request, wherein, the response comprises one or more location identifiers from the set of location identifiers and information to facilitate selection of one location identifier from the one or more location identifiers.

16. The medium of claim 15, wherein the first location identifier comprises a short Uniform Resource Locator (URL).

17. The medium of claim 15, wherein the location identifiers associated with the first location identifier comprise one or more URLs.

18. The medium of claim 15, wherein the information, when read by the machine, causes the machine to further perform transcoding the first location identifier into a location identifier having a different format than the first location identifier.

19. The medium of claim 15, wherein the information, when read by the machine, causes the machine to further perform filtering the set of location identifiers associated with the first location identifier.

20. The medium of claim 15, wherein the information, when read by the machine, causes the machine to further perform returning to the client an executable script for selecting for display one or more resources located at the one or more location identifiers.
